(19) United States
(12) Patent Application Publication
(10) Pub. No.: US 2021/0279007 A1
(43) Pub. Date: Sep. 9, 2021

(54) DEVICE-INITIATED INPUT/OUTPUT ASSISTANCE FOR COMPUTATIONAL NON-VOLATILE MEMORY ON DISK-CACHED AND TIERED SYSTEMS

(71) Applicant: Intel Corporation, Santa Clara, CA (US)

(72) Inventor: Sanjeev Trika, Portland, OR (US)

(21) Appl. No.: 17/313,668

(22) Filed: May 6, 2021

(51) Int. Cl. G06F 3/06

(52) U.S. Cl. CPC G06F 3/0659; G06F 3/0685; G06F 3/0647; G06F 3/061

(57) ABSTRACT

Systems, apparatuses and methods may provide for controller technology that detects an application function, selects a target storage device from a plurality of storage devices including a first storage device and a second storage device that operates more slowly than the first storage device, and issue the application function to the target storage device. Additionally, storage device technology may identify data that is not present on non-volatile memory (NVM) of the storage device, generate an instruction to retrieve the data, and send the instruction to an external controller.

### TECHNICAL FIELD

Embodiments generally relate to memory structures. More particularly, embodiments relate to device-initiated input/output (TO) assistance for computational non-volatile memory (NVM) on disk-cached and tiered systems.

### BACKGROUND

Computational Storage is a technique that may move compute operations to data, rather than moving data to the primary central processing unit (CPU) of a system for calculations to be performed. This approach can take many forms such as, for example, moving application-specified functions to execute on a controller/CPU that is a level logically “above” a caching subsystem having one or more drives. Although the reduction in data movement may result in significant performance and power advantages, there remains considerable room for improvement. For example, conventional computational storage techniques may encounter data integrity problems because the data in a given drive may not be current.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a performance-enhanced computing system according to an embodiment;

FIG. 2 is a flowchart of an example of a method of operating a controller according to an embodiment;

FIG. 3A is a flowchart of an example of a method of handling a split data condition when a data range to operate on is specified at function start-time according to an embodiment;

FIG. 3B is a flowchart of an example of a method of handling a unified data condition when a data range to operate on is specified at function start-time according to an embodiment;

FIG. 4A is a flowchart of an example of a method of supporting computations in a relatively slow storage device when a data range to operate on is determined dynamically at run-time according to an embodiment;

FIG. 4B is a flowchart of an example of a method of supporting computations in a relatively fast storage device when a data range to operate on is determined dynamically at run-time according to an embodiment;

FIGS. 5 and 6 are flowcharts of examples of methods of operating a storage device according to embodiments; and

FIG. 7 is an illustration of an example of a semiconductor apparatus according to an embodiment.

### DESCRIPTION OF EMBODIMENTS

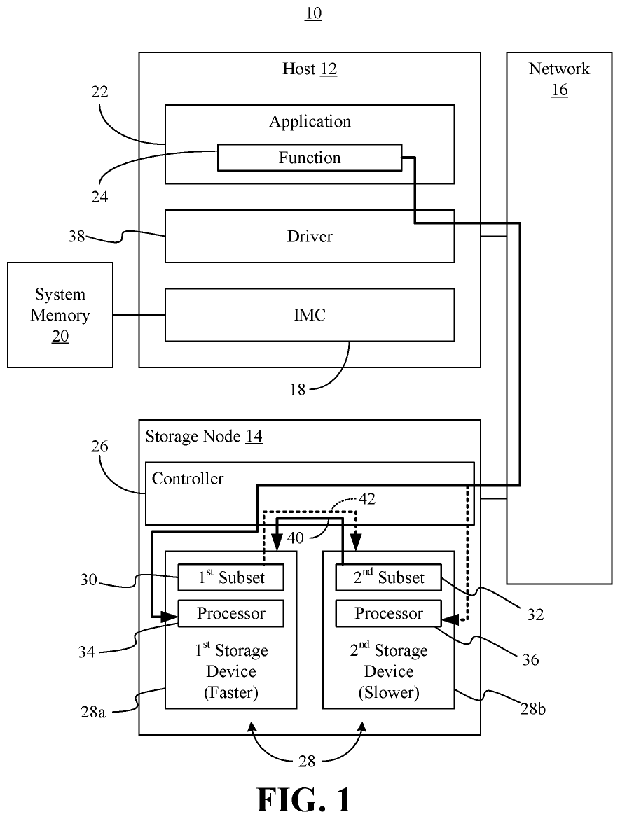

Turning now to FIG. 1, a computing system 10 is shown in which a host device 12 (e.g., CPU, host processor) is coupled to a storage node 14 via a network 16 (e.g., bus, switch). Alternatively, the host device 12 and the storage node 14 may communicate with one another without using the network 16 (e.g., in a single node architecture). The illustrated host device 12 includes an integrated memory controller (IMC) 18 coupled to a system memory 20 (e.g., dynamic random access memory/DRAM). In an embodiment, the host device 12 includes an application 22 (e.g., database application) that includes a function 24 (e.g., search function). The function 24 may operate on relatively large amounts of data located in the storage node 14. Rather than moving the data from the storage node 14 to the host device 12, a driver 38 transfers the function 24 to the storage node 14 for execution. In an embodiment, the storage node 14 includes a controller 26 (e.g., cache controller, tier controller) and a plurality of storage devices 28 (28a, 28b).

More particularly, the plurality of storage devices 28 include a first storage device 28a having a first processor 34 and a second storage device 28b having a second processor 36, wherein the processors 34, 36 are able to execute the function 24. In the illustrated example, the second storage device 28b operates more slowly than the first storage device 28a. Thus, in a disk-caching environment, the first (e.g., relatively fast) storage device 28a may be a caching storage device (e.g., INTEL OPTANE solid state drive/SSD) for the second (e.g., relatively slow) storage device 28b, which is used as a backing storage device (e.g., quad-level cell/QLC SSD). In a tiered environment, both storage devices 28 may be tiered storage devices, with the first storage device 28a being assigned to a lower tier than the second storage device 28b.

In an embodiment, a first subset 30 of the data used by the function 24 is located on the first storage device 28a and a second subset 32 of the data used by the function 24 is stored on the second storage device 28b. For example, the first subset 30 may represent “dirty” cache data that has been recently or frequently used by the function 24 and the second subset 32 may include a stale version of the first subset 30 as well as other data not in the first subset 30. Although two storage devices 28 are shown, the storage node 14 may include multiple front end devices caching/tiering multiple back end devices.

Data Range to Operate on is Specified at Function Start-Time

The user-specified function 24 to run on the cached volume may generally be denoted by λ (params1). In most cases, the data range to operate on is specified by the application 22 when the function 24 is triggered (e.g., a search operation on a database table specifies the search parameters, and the location of the table on the disk). The data may in general be specified by a collection of logical block address/LBA-offset-byteLength tuples (e.g., data specifiers), which may be denoted collectively by the symbol “D”. In an embodiment, D is derived by the application 22 and/or file-system from higher level file-object, offset, and length specifiers.

In this solution, both D and λ are first passed down to the controller 26, which identifies portions of D that are dirty and in the first storage device 28a (e.g., cache) using lookup procedures. As a result, D may be divided into the first subset 30 of data (D faster) and the second subset 32 of data (D_{slower}), where the former is dirty in the first storage device 28a, and the latter is not. If D_{slower} is empty, then the controller 26 issues λ(Map(D)) to the computational-storage enabled first storage device 28a (e.g., INTEL OPTANE SSD). In an embodiment, “Map” is a cache-map operation that creates data-specifiers D′, which indicate the location of the cached-data, corresponding to D, on the first storage device 28a. The result of the operation may be returned by the first storage device 28a to the controller 26, which in turn sends the result to the application 22.

Otherwise, the controller 26 may transfer (e.g., via a cache flush) the first subset 30 to the second storage device 28b (e.g., backing QLC SSD), and then issue λ(D) to the computational-storage enabled second storage device 28b. Alternately, if the number of dirties is small in the cache, then the entire cache may be cleaned before λ(D) is issued to the second storage device 28b. In an embodiment, the result of the operation is returned by the second storage device 28b to the controller 26, which in turn sends the result to the calling application 22.

Data Range to Operate on is Determined Dynamically at Run-Time

This case is more general in which the data range to operate λ( ) on is specified by another function d(params2). When d( ) is called, it returns a data specifier (LBA-offset-bytetLength tuple) on which to operate. In one example, subsequent calls generate new data specifiers, where calls to d( ) are parametrized by λ. For example, λ may call d(A) if a condition is true (e.g., based on some calculations), and otherwise call d(B) to determine the data range on which to operate. Since the data specifiers are not known at λ start-time, it may not be possible to determine upfront whether the relevant data is in the first storage device 28a or the second storage device 28b. Multiple sub-approaches may be used to address this issue.

Execution on the Slower Media

One solution is to issue a new BackingMediaCompStorage(λ(params1), d( )) call to the second storage device 28b, where the full span of the data volume and majority of the data may reside. In an embodiment, the second storage device 28b, is both computational-storage enabled and aware that the second storage device 28b is being cached. The call may be standardized or vendor-specific. The second storage device 28b starts executing λ, calling d( ) as specified in the λ-logic. As d( ) returns data specifiers, the second storage device 28b instructs the controller 26 to transfer 42 (e.g., via a flush) the first subset 30 (e.g., corresponding “dirties”) to the second storage device 28b, via a new FlushDirties(D) interface between the controller 26 and the second storage device 28b. In one example, the new interface is a command/instruction that is initiated by the second storage device 28b and processed by the controller 26. The new interface may be implemented in two phases in which the second storage device 28b first queries the controller 26 about which LBAs are dirty, and then requests data for those LBAs.

Execution on the Faster Media

This solution may involve a new FrontMediaCompStorage(λ(params1), d( ) command. In some cases, this solution provides higher performance because the first storage device 28a may by design contain most frequently touched data that the user is likely operating on. In an embodiment, the first storage device 28a is both computational-storage enabled and aware that the first storage device 28a is the fronting media in a cache hierarchy. The first storage device 28a may start executing λ, calling d( ) as specified in the λ-logic. As d( ) returns data specifiers, the first storage device 28a obtains assistance (e.g., using a new interface) from the controller 26 to determine whether the data specified by the returned data specifier D is in the first subset 30 in the first storage device 28a and the local mapping. If so, the first processor 34 operates λ on the first subset 30. Otherwise, the first storage device 28a requests that the controller 26 transfer 40 the missing data in the second subset 32 to the first storage device 28a for further processing. Thus, the first storage device 28a initiates data transfer requests.

The computing system 10 is therefore performance-enhanced at least to the extent that the majority of the data used by the function 24 does not need to be moved to the controller 26 and merged in the controller 26 before processing. Indeed, moving only subsets of the data and executing the function 24 on the storage devices 28 may also reduce power consumption.

The storage devices 28 may be part of a memory device that includes non-volatile memory and/or volatile memory. Non-volatile memory is a storage medium that does not require power to maintain the state of data stored by the medium. In one embodiment, the memory structure is a block addressable storage device, such as those based on NAND or NOR technologies. A storage device may also include future generation nonvolatile devices, such as a three-dimensional (3D) crosspoint memory device, or other byte addressable write-in-place nonvolatile memory devices. In one embodiment, the storage device may be or may include memory devices that use silicon-oxide-nitride-oxide-silicon (SONOS) memory, electrically erasable programmable read-only memory (EEPROM), chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thiristor based memory device, or a combination of any of the above, or other memory. The term “storage device” may refer to the die itself and/or to a packaged memory product. In some embodiments, 3D crosspoint memory may comprise a transistor-less stackable cross point architecture in which memory cells sit at the intersection of word lines and bit lines and are individually addressable and in which bit storage is based on a change in bulk resistance. In particular embodiments, a memory module with non-volatile memory may comply with one or more standards promulgated by the Joint Electron Device Engineering Council (JEDEC), such as JESD235, JESD218, JESD219, JESD220-1, JESD223B, JESD223-1, or other suitable standard (the JEDEC standards cited herein are available at jedec.org).

Volatile memory is a storage medium that requires power to maintain the state of data stored by the medium. Examples of volatile memory may include various types of random access memory (RAM), such as dynamic random access memory (DRAM) or static random access memory (SRAM). One particular type of DRAM that may be used in a memory module is synchronous dynamic random access memory (SDRAM). In particular embodiments, DRAM of the memory modules complies with a standard promulgated by JEDEC, such as JESD79F for Double Data Rate (DDR) SDRAM, JESD79-2F for DDR2 SDRAM, JESD79-3F for DDR3 SDRAM, or JESD79-4A for DDR4 SDRAM (these standards are available at jedec.org). Such standards (and similar standards) may be referred to as DDR-based standards and communication interfaces of the storage devices that implement such standards may be referred to as DDR-based interfaces.

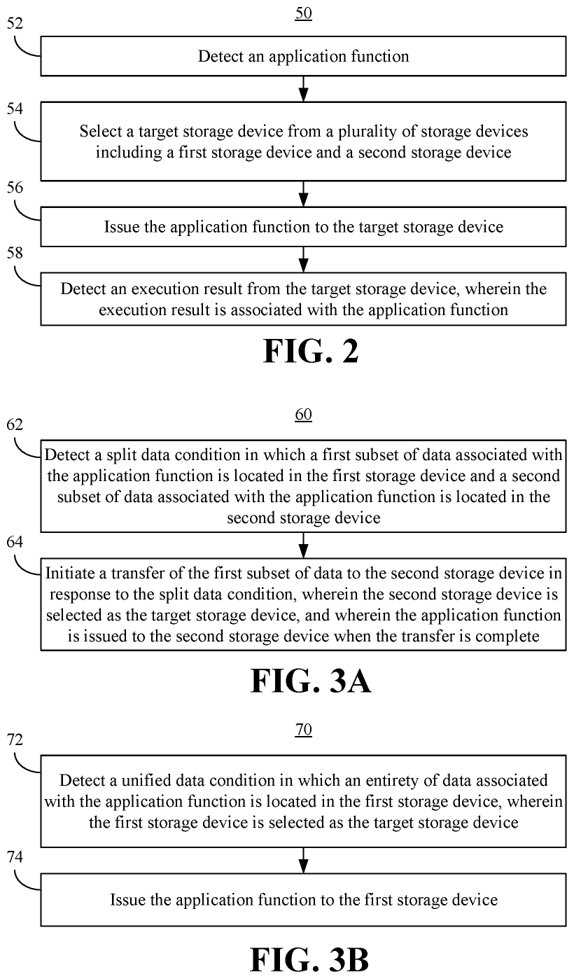

FIG. 2 shows a method 50 of operating a performance-enhanced controller. The method 50 may generally be implemented in a controller such as, for example, the controller 26 (FIG. 1), already discussed. More particularly, the method 50 may be implemented in a set of logic instructions stored in a machine- or computer-readable storage medium such as RAM, ROM, PROM, firmware, flash memory, etc., configurable logic such as, for example, programmable logic arrays (PLAs), field-programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

Illustrated processing block 52 provides for detecting an application function (e.g., database search function). Block 52 may include receiving one or more signals, messages and/or packets from a host device via a network, wherein the one or more signals/packets/messages include the application function. In an embodiment, block 54 selects a target (e.g., computational) storage device from a plurality of storage devices including a first storage device and a second storage device. The second storage device may operate more slowly than the first storage device. In one example, the first storage device is a caching storage device and the second storage device is a backing storage device. In another example, the first storage device and the second storage device are tiered storage devices. Block 56 issues the application function to the target storage device. In an embodiment, block 58 detects (e.g., via one or more signals, messages and/or packets) an execution result from the target storage device. In the illustrated example, the execution result is associated with the application function.

The method 50 enhances performance at least to the extent that offloading execution of the application function to the target storage device obviates any need to merge data used by the application function at the controller. Indeed, eliminating the input/output (IO) data transfers associated with merging data at the controller may also reduce power consumption.

FIG. 3A shows a method 60 of handling a split data condition when a data range to operate on is specified at function start-time. The method 60 may generally be implemented in a controller such as, for example, the controller 26 (FIG. 1), already discussed. More particularly, the method 60 may be implemented in a set of logic instructions stored in a machine- or computer-readable storage medium such as RAM, ROM, PROM, firmware, flash memory, etc., configurable logic such as, for example, PLAs, FPGAs, CPLDs, in fixed-functionality hardware logic using circuit technology such as, for example, ASIC, CMOS or TTL technology, or any combination thereof.

Illustrated processing block 62 provides for detecting a split data condition in which a first subset (e.g., dirty cache lines) of data associated with the application function is located in the first storage device and a second subset of data is located in the second storage device. In an embodiment, block 64 initiates a transfer of the first subset of data to the second storage device in response to the split data condition. In the illustrated example, the second storage device is selected as the target storage device and the application function is issued to the second storage device when the transfer is complete.

FIG. 3B shows a method 70 of handling a unified data condition when a data range to operate on is specified at function start-time. The method 70 may generally be implemented in a controller such as, for example, the controller 26 (FIG. 1), already discussed. More particularly, the method 70 may be implemented in a set of logic instructions stored in a machine- or computer-readable storage medium such as RAM, ROM, PROM, firmware, flash memory, etc., configurable logic such as, for example, PLAs, FPGAs, CPLDs, in fixed-functionality hardware logic using circuit technology such as, for example, ASIC, CMOS or TTL technology, or any combination thereof.

Illustrated processing block 72 provides for detecting a unified data condition in which an entirety of data associated with (e.g., processed by) the application function is located in the first storage device. In the illustrated example, the first storage device is selected as the target storage device. In an embodiment, block 74 issues the application function to the first storage device. Block 74 may also issue a map (e.g., cache map) to the first storage device along with the application function, wherein the map enables the first storage device to locate the data in a disk-caching environment.

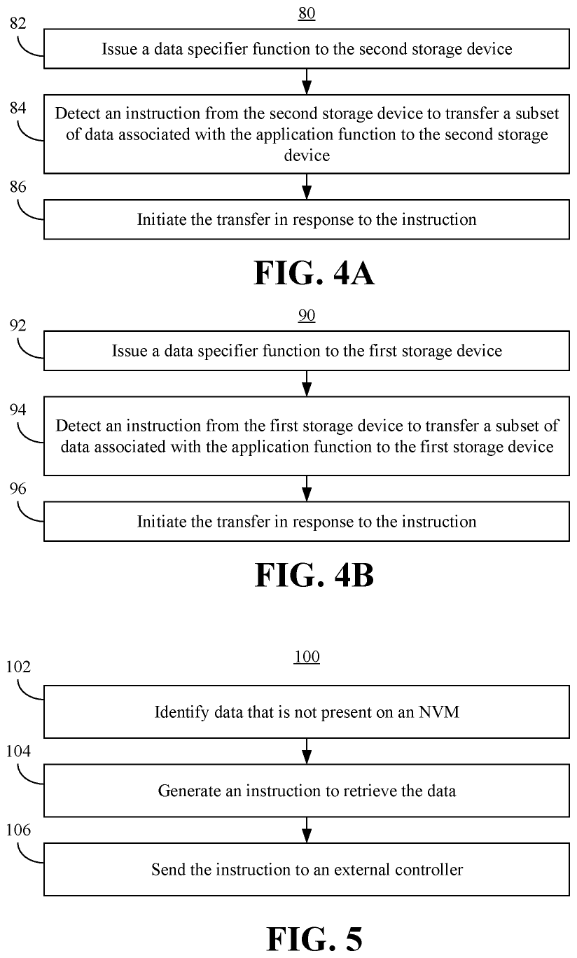

FIG. 4A shows a method 80 of supporting computations in a relatively slow storage device when a data range to operate on is determined dynamically at run-time. The method 80 may generally be implemented in a controller such as, for example, the controller 26 (FIG. 1), already discussed. More particularly, the method 80 may be implemented in a set of logic instructions stored in a machine- or computer-readable storage medium such as RAM, ROM, PROM, firmware, flash memory, etc., configurable logic such as, for example, PLAs, FPGAs, CPLDs, in fixed-functionality hardware logic using circuit technology such as, for example, ASIC, CMOS or TTL technology, or any combination thereof.

In general, the second (e.g., slower) storage device may be selected as the target storage device. Illustrated processing block 82 provides for issuing a data specifier function to the second storage device. In an embodiment, block 84 detects (e.g., receives) an instruction from the second storage device to transfer a subset of data associated with the application function to the second storage device. Block 86 may initiate the transfer (e.g., via a cache flush) in response to the instruction.

FIG. 4B shows a method 90 of supporting computations in a relatively fast storage device when a data range to operate on is determined dynamically at run-time. The method 90 may generally be implemented in a controller such as, for example, the controller 26 (FIG. 1), already discussed. More particularly, the method 90 may be implemented in a set of logic instructions stored in a machine- or computer-readable storage medium such as RAM, ROM, PROM, firmware, flash memory, etc., configurable logic such as, for example, PLAs, FPGAs, CPLDs, in fixed-functionality hardware logic using circuit technology such as, for example, ASIC, CMOS or TTL technology, or any combination thereof.

In general, the first (e.g., faster) storage device may be selected as the target storage device. Illustrated processing block 92 provides for issuing a data specifier function to the first storage device. In an embodiment, block 94 detects (e.g., receives) an instruction from the first storage device to transfer a subset of data associated with the application function to the first storage device. Block 96 may initiate the transfer in response to the instruction.

FIG. 5 shows a method 100 of operating a storage device. The method 100 may generally be implemented in a storage device such as, for example, the first storage device 28a (FIG. 1) and/or the second storage device 28b (FIG. 1), already discussed. More particularly, the method 100 may be implemented in a set of logic instructions stored in a machine- or computer-readable storage medium such as RAM, ROM, PROM, firmware, flash memory, etc., configurable logic such as, for example, PLAs, FPGAs, CPLDs, in fixed-functionality hardware logic using circuit technology such as, for example, ASIC, CMOS or TTL technology, or any combination thereof.

Illustrated processing block 102 provides for identifying data that is not present in NVM of the storage device. In an embodiment, block 102 includes detecting an application function from an external controller, wherein the data is identified based on the application function. For example, the application function might be a search operation on a database table that is located on a caching storage device or another tiered storage device. The application function may also be an internal function (e.g., scrub function) that is not provided by the external controller. Indeed, the data that is not present in the NVM might be associated with a sector of the NVM that is going bad. Block 104 may generate an instruction to retrieve the data. In one example, the instruction specifies a source of the data. As already noted, the source may be a caching storage device, a backing storage device and/or a tiered storage device. Block 106 sends the instruction to an external controller (e.g., cache controller). The method 100 therefore enhances performance at least to the extent that enabling the storage device to request data from external sources extends the operating features of the storage device.

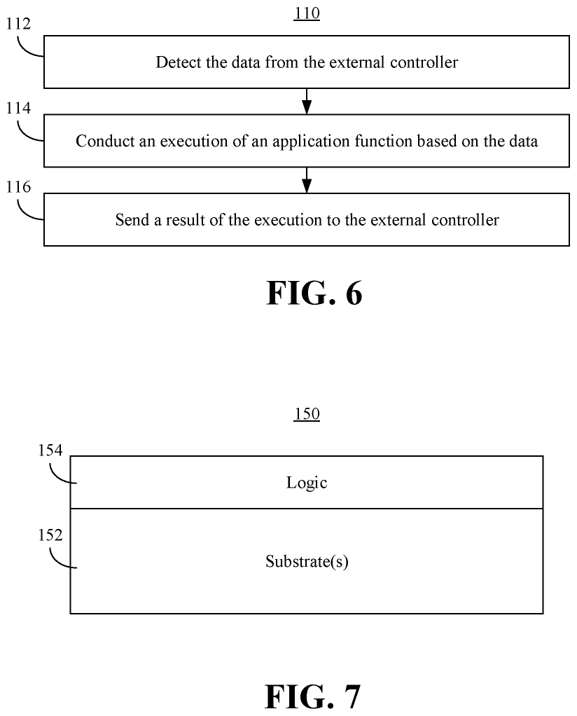

FIG. 6 shows a method 110 of operating a storage device. The method 110 may generally be implemented in a storage device such as, for example, the first storage device 28a (FIG. 1) and/or the second storage device 28b (FIG. 1) and after the method 100 (FIG. 5), already discussed. More particularly, the method 110 may be implemented in a set of logic instructions stored in a machine- or computer-readable storage medium such as RAM, ROM, PROM, firmware, flash memory, etc., configurable logic such as, for example, PLAs, FPGAs, CPLDs, in fixed-functionality hardware logic using circuit technology such as, for example, ASIC, CMOS or TTL technology, or any combination thereof.

Illustrated processing block 112 provides for detecting the requested data (e.g., data requested via the method 100 in FIG. 5) from the external controller, wherein block 114 conducts an execution of an application function based on the data. In an embodiment, block 116 sends a result of the execution to the external controller. Thus, block 116 might involve sending the result of a databased search operation.

FIG. 7 shows a semiconductor apparatus 150 (e.g., chip and/or package). The illustrated apparatus 150 includes one or more substrates 152 (e.g., silicon, sapphire, gallium arsenide) and logic 154 (e.g., transistor array and other integrated circuit/IC components) coupled to the substrate(s) 152. In an embodiment, the logic 154 implements one or more aspects of the method 50 (FIG. 2), the method 60 (FIG. 3A), the method 70 (FIG. 3B), the method 80 (FIG. 4A), the method 90 (FIG. 4B), the method 100 (FIG. 5) and/or the method 110 (FIG. 6), already discussed.

Thus, when operated as a controller, the logic 154 may detect an application function and select a target storage device from a plurality of storage devices including a first storage device and a second storage device that operates more slowly than the first storage device. The logic 154 may also issue the application function to the target storage device.

When operated as a processor in a storage device, the logic 154 may identify data that is not present in NVM of the storage device and generate an instruction to retrieve the data. The logic 154 may also send the instruction to an external controller.

In one example, the logic 154 includes transistor channel regions that are positioned (e.g., embedded) within the substrate(s) 152. Thus, the interface between the logic 154 and the substrate 152 may not be an abrupt junction. The logic 154 may also be considered to include an epitaxial layer that is grown on an initial wafer of the substrate 152.

### ADDITIONAL NOTES AND EXAMPLES

Example 1 includes a performance-enhanced controller comprising one or more substrates and logic coupled to the one or more substrates, wherein the logic is at least partly implemented in one or more of configurable or fixed-functionality hardware, and the logic coupled to the one or more substrates is to detect an application function, select a target storage device from a plurality of storage devices including a first storage device and a second storage device, and issue the application function to the target storage device.

Example 2 includes the controller of Example 1, wherein the logic coupled to the one or more substrates is to detect an execution result from the target storage device, wherein the execution result is associated with the application function.

Example 3 includes the controller of Example 1, wherein the logic coupled to the one or more substrates is to detect a split data condition in which a first subset of data associated with the application function is located in the first storage device and a second subset of data associated with the application function is located in the second storage device, and initiate a transfer of the first subset of data to the second storage device in response to the split data condition, wherein the second storage device is selected as the target storage device, and wherein the application function is issued to the second storage device when the transfer is complete.

Example 4 includes the controller of Example 1, wherein the logic coupled to the one or more substrates is to detect a unified data condition in which an entirety of data associated with the application function is located in the first storage device, wherein the first storage device is selected as the target storage device, and issue the application function to the first storage device.

Example 5 includes the controller of Example 1, wherein the second storage device is selected as the target storage device, and wherein the logic coupled to the one or more substrates is to issue a data specifier function to the second storage device, detect an instruction from the second storage device to transfer a subset of data associated with the application function from the first storage device to the second storage device, and initiate the transfer in response to the instruction.

Example 6 includes the controller of Example 1, wherein the first storage device is selected as the target storage device, and wherein the logic coupled to the one or more substrates is to issue a data specifier function to the first storage device, detect an instruction from the first storage device to transfer a subset of data associated with the application function from the second storage device to the first storage device, and initiate the transfer in response to the instruction.

Example 7 includes the controller of any one of Examples 1 to 6, wherein the first storage device is to be a caching storage device and the second storage device is to be a backing storage device, and wherein the second device is to operate more slowly than the first device.

Example 8 includes the controller of any one of Examples 1 to 6, wherein the first storage device and the second storage device are to be tiered storage devices, and wherein the second device is to operate more slowly than the first device.

Example 9 includes a performance-enhanced storage node comprising a plurality of storage devices including a first storage device and a second storage device, and a controller coupled to the plurality of storage devices, the controller including logic coupled to one more substrates, wherein the logic is to detect an application function, select a target storage device from the plurality of storage devices, and issue the application function to the target storage device.

Example 10 includes the storage node of Example 9, wherein the logic coupled to the one or more substrates is to detect an execution result from the target storage device, wherein the execution result is associated with the application function.

Example 11 includes the storage node of Example 9, wherein the logic coupled to the one or more substrates is to detect a split data condition in which a first subset of data associated with the application function is located in the first storage device and a second subset of data associated with the application function is located in the second storage device, and initiate a transfer of the first subset of data to the second storage device in response to the split data condition, wherein the second storage device is selected as the target storage device, and wherein the application function is issued to the second storage device when the transfer is complete.

Example 12 includes the storage node of Example 9, wherein the logic coupled to the one or more substrates is to detect a unified data condition in which an entirety of data associated with the application function is located in the first storage device, wherein the first storage device is selected as the target storage device, and issue the application function to the first storage device.

Example 13 includes the storage node of Example 9, wherein the second storage device is selected as the target storage device, and wherein the logic coupled to the one or more substrates is to issue a data specifier function to the second storage device, detect an instruction from the second storage device to transfer a subset of data associated with the application function from the first storage device to the second storage device, and initiate the transfer in response to the instruction.

Example 14 includes the storage node of Example 9, wherein the first storage device is selected as the target storage device, and wherein the logic coupled to the one or more substrates is to issue a data specifier function to the first storage device, detect an instruction from the first storage device to transfer a subset of data associated with the application function from the second storage device to the first storage device, and initiate the transfer in response to the instruction.

Example 15 includes the storage node of any one of Examples 9 to 14, wherein the first storage device is a caching storage device and the second storage device is a backing storage device, and wherein the second device is to operate more slowly than the first device.

Example 16 includes the storage node of any one of Examples 9 to 14, wherein the first storage device and the second storage device are to be tiered storage devices, and wherein the second device is to operate more slowly than the first device.

Example 17 includes a performance-enhanced storage device comprising a non-volatile memory (NVM), and a processor coupled to the NVM, the processor including logic coupled to one or more substrates, wherein the logic is to identify data that is not present on the NVM, generate an instruction to retrieve the data, and send the instruction to an external controller.

Example 18 includes the storage device of Example 17, wherein the logic coupled to the one or more substrates is to detect the data from external controller, conduct an execution of an application function based on the data, and send a result of the execution to the external controller.

Example 19 includes the storage device of Example 18, wherein the logic coupled to the one or more substrates is to detect the application function from the external controller, and wherein the data is identified based on the application function.

Example 20 includes the storage device of Example 17, wherein the instruction is to specify a source of the data, and wherein the source is to be one or more of a caching storage device, a backing storage device, or a tiered storage device.

Technology described herein therefore introduces new interfaces for SSD devices to initiate data requests. The technology may also solve cache coherency problems encountered in CXL (Compute Express Link) memory architectures. The technology may be deployed in cache controller products such as, for example, CAS (Cache Acceleration Software), RST (Rapid Storage Technology), RSTe (RST Enterprise), VROC (Virtual RAID/Redundant Array of Independent Disks on CPU), and so forth.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A controller comprising:
one or more substrates; and
logic coupled to the one or more substrates, wherein the logic is at least partly implemented in one or more of configurable or fixed-functionality hardware, and the logic coupled to the one or more substrates is to:
detect an application function;
select a target storage device from a plurality of storage devices including a first storage device and a second storage device; and
issue the application function to the target storage device.

2. The controller of claim 1, wherein the logic coupled to the one or more substrates is to detect an execution result from the target storage device, wherein the execution result is associated with the application function.

3. The controller of claim 1, wherein the logic coupled to the one or more substrates is to:
detect a split data condition in which a first subset of data associated with the application function is located in the first storage device and a second subset of data associated with the application function is located in the second storage device; and
initiate a transfer of the first subset of data to the second storage device in response to the split data condition, wherein the second storage device is selected as the target storage device, and wherein the application function is issued to the second storage device when the transfer is complete.

4. The controller of claim 1, wherein the logic coupled to the one or more substrates is to:
detect a unified data condition in which an entirety of data associated with the application function is located in the first storage device, wherein the first storage device is selected as the target storage device; and
issue the application function to the first storage device.

5. The controller of claim 1, wherein the second storage device is selected as the target storage device, and wherein the logic coupled to the one or more substrates is to:
issue a data specifier function to the second storage device;
detect an instruction from the second storage device to transfer a subset of data associated with the application function from the first storage device to the second storage device; and
initiate the transfer in response to the instruction.

6. The controller of claim 1, wherein the first storage device is selected as the target storage device, and wherein the logic coupled to the one or more substrates is to:
issue a data specifier function to the first storage device;
detect an instruction from the first storage device to transfer a subset of data associated with the application function from the second storage device to the first storage device; and
initiate the transfer in response to the instruction.

7. The controller of claim 1, wherein the first storage device is to be a caching storage device and the second storage device is to be a backing storage device, and wherein the second device is to operate more slowly than the first device.

8. The controller of claim 1, wherein the first storage device and the second storage device are to be tiered storage devices, and wherein the second device is to operate more slowly than the first device.

9. A storage node comprising:
a plurality of storage devices including a first storage device and a second storage device; and
a controller coupled to the plurality of storage devices, the controller including logic coupled to one more substrates, wherein the logic is to:
detect an application function,
select a target storage device from the plurality of storage devices, and
issue the application function to the target storage device.

10. The storage node of claim 9, wherein the logic coupled to the one or more substrates is to detect an execution result from the target storage device, wherein the execution result is associated with the application function.

11. The storage node of claim 9, wherein the logic coupled to the one or more substrates is to:
detect a split data condition in which a first subset of data associated with the application function is located in the first storage device and a second subset of data associated with the application function is located in the second storage device, and
initiate a transfer of the first subset of data to the second storage device in response to the split data condition, wherein the second storage device is selected as the target storage device, and wherein the application function is issued to the second storage device when the transfer is complete.

12. The storage node of claim 9, wherein the logic coupled to the one or more substrates is to:
detect a unified data condition in which an entirety of data associated with the application function is located in the first storage device, wherein the first storage device is selected as the target storage device, and
issue the application function to the first storage device.

13. The storage node of claim 9, wherein the second storage device is selected as the target storage device, and wherein the logic coupled to the one or more substrates is to:
issue a data specifier function to the second storage device,
detect an instruction from the second storage device to transfer a subset of data associated with the application function from the first storage device to the second storage device, and
initiate the transfer in response to the instruction.

14. The storage node of claim 9, wherein the first storage device is selected as the target storage device, and wherein the logic coupled to the one or more substrates is to:
issue a data specifier function to the first storage device,
detect an instruction from the first storage device to transfer a subset of data associated with the application function from the second storage device to the first storage device, and
initiate the transfer in response to the instruction.

15. The storage node of claim 9, wherein the first storage device is a caching storage device and the second storage device is a backing storage device, and wherein the second device is to operate more slowly than the first device.

16. The storage node of claim 9, wherein the first storage device and the second storage device are to be tiered storage devices, and wherein the second device is to operate more slowly than the first device.

17. A storage device comprising:
a non-volatile memory (NVM); and
a processor coupled to the NVM, the processor including logic coupled to one or more substrates, wherein the logic is to:
identify data that is not present on the NVM,
generate an instruction to retrieve the data, and
send the instruction to an external controller.

18. The storage device of claim 17, wherein the logic coupled to the one or more substrates is to:
detect the data from external controller,
conduct an execution of an application function based on the data, and send a result of the execution to the external controller.

19. The storage device of claim 18, wherein the logic coupled to the one or more substrates is to detect the application function from the external controller, and wherein the data is identified based on the application function.

20. The storage device of claim 17, wherein the instruction is to specify a source of the data, and wherein the source is to be one or more of a caching storage device, a backing storage device, or a tiered storage device.
